(19) United States
(12) Patent Application Publication
(10) Pub. No.: US 2006/0007163 A1
(43) Pub. Date: Jan. 12, 2006

(54) Optical pen with page-scrolling function

(75) Inventor: Shui-Chuan Chiang, Hsin Chu City (TW)

Correspondence Address: TROXELL LAW OFFICE PLLC, SUITE 1404, 5205 LEESBURG PIKE, FALLS CHURCH, VA, 22041, US

(73) Assignee: AIPTEK INTERNATIONAL INC.

(21) Appl. No.: 10/885,629

(22) Filed: Jul. 8, 2004

(51) Int. Cl. G09G 5/00

(52) U.S. Cl. 345/169

(57) ABSTRACT

An optical pen with page-scrolling function connects to an electronic device for browsing and page-scrolling by outputting an operational signal to the electronic device. The optical pen has an optical sensor for emitting light and receiving a signal of reflected light, an operating unit outputting an operational signal, and a controller connected to the optical sensor and the operating unit for processing the signal of reflected light and the operational signal, and outputting the processing result to the electronic device.

### BACKGROUND OF THE INVENTION

1. Field of the Invention

The present invention relates to an optical pen with a page-scrolling function, and more particularly relates to an optical pen connected to an electronic device for browsing and page-scrolling functions by outputting an operational signal to the electronic device.

2. Description of the Related Art

A mouse is an important input device, and is classified as a mechanical mouse or an optical mouse according to sensor type. The mouse is developed to have an ergonomic shape for comfortable operation. The optical pen enables a user to write smoothly and is carried conveniently.

The prior art optical pen has only the functions of right key, left key and handwriting input, and cannot be used like a roller for page-scrolling. Moreover, the conventional optical pen also cannot operate like an induction pen, which outputs a pressure signal of the pen to the electronic device for changing the line thickness when writing by hand.

### SUMMARY OF THE INVENTION

The optical pen of the present invention connects to an electronic device. The optical pen of the present invention not only has the function of right key and left key as does a traditional mouse, but also has a roller key for page-scrolling on the electronic device. Moreover, the present invention outputs a pressure signal of the pen applied on paper to the electronic device so as to vary line width when writing by hand.

The optical pen with page-scrolling function of the present invention connects to an electronic device for outputting an operational signal by operating a rolling operation, a buttoning operation and a clicking operation. The operational signal is processed by a controller in the optical pen. After processing the operational signal, the controller transmits the operational signal to the electronic device for executing page-scrolling, a right key click or a left key click, and displays the line thickness hand-written characters on the window of the electronic device.

The optical pen with page-scrolling function of the present invention uses an optical sensor for emitting light and receiving a signal of reflected light. The signal of reflected light is a location signal of the optical pen on paper. The location signal of the optical pen on paper is transmitted to the controller, which is connected to the optical sensor. After processing the location signal of the optical pen on paper, the controller transmits the location signal to the electronic device as an index signal.

### BRIEF DESCRIPTION OF THE DRAWINGS

The various objects and advantages of the present invention will be more readily understood from the following detailed description when read in conjunction with the appended drawing, in which:

FIG. 1 shows a perspective drawing of the optical pen of the present invention connects to the electronic device;

FIG. 2 shows a circuit block diagram of the present invention; and

FIG. 3 shows another circuit block diagram of the present invention.

### DETAILED DESCRIPTION OF PREFERRED EMBODIMENTS

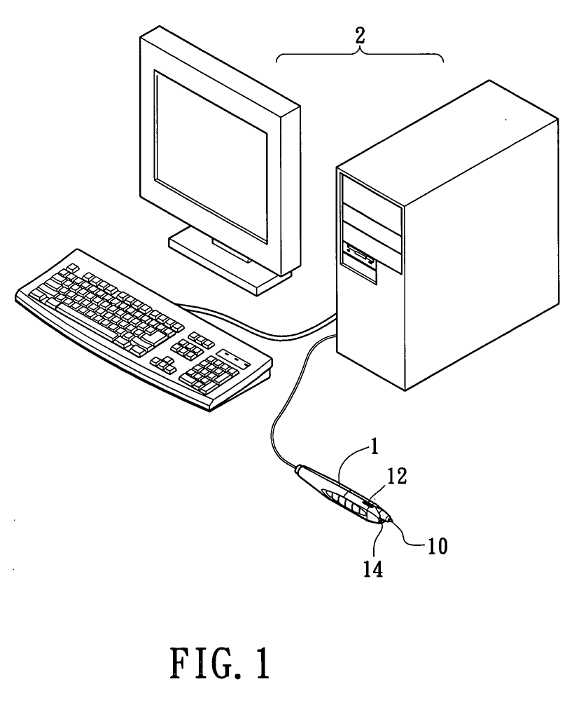

FIG. 1 shows a perspective drawing of the optical pen of the present invention connected to the electronic device. The optical pen 1 with a page-scrolling function connects to an electronic device 2 for operating the left key like a traditional mouse and receiving a pressure signal of the pen on paper by a click operation key 10. The optical pen 1 has a roller operation key 12, and the optical pen 1 outputs an operational signal to the electronic device 2 by a rolling operation and a pressing operation with the roller operation key 12. The pressing operation is a right key click of the traditional mouse. Moreover, the optical pen 1 emits light and receives a signal of reflected light to obtain a location signal of the optical pen 1 on paper by an optical sensor 14, and the location signal is transmitted to the electronic device 2 as an index signal for a cursor on a window of the electronic device 2.

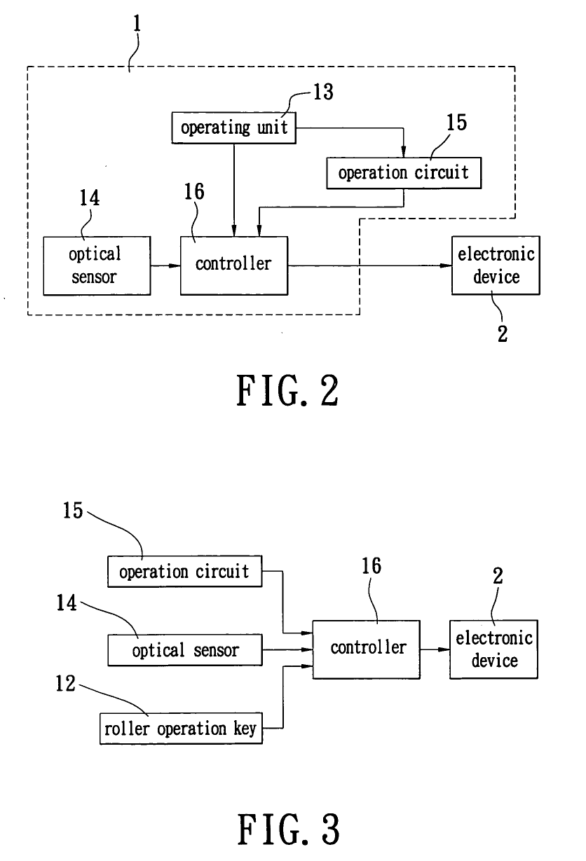

FIG. 2 shows a circuit block diagram of the present invention. The optical pen 1 of the present invention comprises an optical sensor 14, a controller 16, an operating unit 13 and an operation circuit 15.

As shown in FIG. 2, the optical pen 1 connects to the electronic device 2 through the controller 16, and transmits the operational signal to the electronic device 2 by the controller 16. The electronic device 2 is controlled to display the index signal of cursor and perform page-scrolling on the window of the electronic device 2. Moreover, the optical pen 1 outputs a pressure signal to the electronic device 2, which indicates stroke force of pen applied on paper. The thickness of the handwriting on the window of the electronic device 2 is varied according to the pressure signal.

As shown in FIG. 2, the optical sensor 14 emits light and receives the signal of reflected light for obtaining the location signal of the optical pen 1 with respect to paper. The location signal is transmitted to the controller 16 for processing. After processing the operational signal, the controller 16 transmits the processed location signal to the electronic device 2 as an index signal of the optical pen 1 on paper.

As shown in FIG. 2, the operating unit 13 connected to the controller 16 is a roller operation key 12 (shown in FIG. 1). The user dials the roller operation key 12 to perform a rolling operation so as to transmit the operational signal to the electronic device 2 for synchronous page-scrolling. The user can also press the roller operation key 12 to perform a buttoning operation so as to transmit the operational signal to the controller 16 for processing. After processing the operational signal, the controller 16 transmits the operational signal to the electronic device 2 for executing an interrupted program synchronously, and the buttoning operation is the right key operation of the traditional mouse.

As shown in FIG. 2, the operating unit 13 connects to the controller 16 through the operation circuit 15, and the operating unit 13 is a click operation key. The user contacts the optical pen bin to operate a clicking operation so as to transmit the operational signal to the controller 16 for processing. After processing the operational signal, the controller 16 transmits the operational signal to the electronic device 2 for executing an interrupted program synchronously, and the clicking operation fulfills the left key operation of the traditional mouse.

As mentioned above, the operation circuit 15 outputs a pressure signal of the pen applied on paper to the controller 16 during the clicking operation. After processing the signal, the controller 16 transmits the signal to the electronic device 2, and displays the font thickness of the handwriting on the window of the electronic device 2.

FIG. 3 shows another circuit block diagram of the present invention. The controller 16 is connected to the operation circuit 15, the optical sensor 14, the roller operation key 12 and the electronic device 2. The operation circuit 15 receives a pressure signal of the pen applied on paper and a click operational signal, and then transmits the signals to the controller 16 for processing. After processing the signals, the controller 16 transmits the signals to the electronic device 2, and displays the line thickness of the handwriting on the window of the electronic device 2. The click operational signal is produced by the operation circuit 15 with a clicking operation. The clicking operation fulfills the left key operation of the traditional mouse.

As shown in FIG. 3, the optical sensor 14 emits light and receives the signal of reflected light for obtaining the location signal of the optical pen 1 with respect to paper, and the location signal is transmitted to the controller 16 for processing. After processing the location signal, the controller 16 transmits the location signal to the electronic device 2 as an index signal of the optical pen 1 with respect to paper.

As shown in FIG. 3, the roller operation key 12 (shown in FIG. 1) is connected to the controller 16. Moreover, the user dials the roller operation key 12 to perform a rolling operation so as to transmit an operational signal to the electronic device 2 for synchronously executing page-scrolling.

Furthermore, the optical pen of the present invention is different from the conventional optical pen. The optical pen of the present invention connects to an electronic device for outputting an operational signal by performing a rolling operation, a buttoning operation and a clicking operation. The operational signal is processed by a controller in the optical pen. After processing the operational signal, the controller transmits the operational signal to the electronic device for executing page-scrolling, a right key click and a left key click, and displaying the line thickness of handwriting on the window of the electronic device.

Although the present invention has been described with reference to the preferred embodiment thereof, it will be understood that the invention is not limited to the details thereof. Various substitutions and modifications have been suggested in the foregoing description, and other will occur to the of ordinary skill in the art. Therefore, all such substitutions and modifications are embraced within the scope of the invention as defined in the appended claims.

What is claimed is:

1. An optical pen with a page-scrolling function and connected to an electronic device, the optical pen comprising:
an optical sensor for emitting light and receiving a signal of reflected light;
an operating unit for outputting an operational signal;
a controller connected to the optical sensor and the operating unit for processing the signal of reflected light and the operational signal, and outputting a processing result to the electronic device.

2. The optical pen of claim 1, wherein the signal of reflected light is a location signal of the optical pen with respect to paper.

3. The optical pen of claim 1, wherein the signal of reflected light is an index signal on a display of the electronic device.

4. The optical pen of claim 1, wherein the operating unit is a roller operation key.

5. The optical pen of claim 4, wherein the roller operation key outputs an operational signal by performing a rolling operation.

6. The optical pen of claim 4, wherein the roller operation key outputs the operational signal by performing a buttoning operation.

7. The optical pen of claim 6, wherein the buttoning operation fulfills a right key operation of a traditional mouse.

8. The optical pen of claim 1, wherein the operating unit is a click operation key.

9. The optical pen of claim 8, wherein the click operation key outputs an operational signal by performing a clicking operation.

10. The optical pen of claim 9, wherein the clicking operation fulfills a left key operation of a traditional mouse.

11. The optical pen of claim 9, wherein the clicking operation further produces a pressure signal of the pen applied on paper, and transmits the pressure signal to the controller through an operation circuit.

12. An optical pen with page-scrolling function, connected to an electronic device and comprising:
an operation circuit receiving a pressure signal of the pen applied on paper and a click operational signal from a nib of the optical pen;
an optical sensor emitting light and receiving a signal of reflected light, wherein the signal of reflected light is a location signal of the optical pen with respect to paper;
a roller operation key, wherein the roller operation key outputs an operational signal; and
a controller connected to the operation circuit, the optical sensor and the roller operation key for processing the pressure signal of the pen applied on paper, the click operational signal, the location signal of the optical pen on paper and the operational signal so as to output a process result the electronic device.

13. The optical pen of claim 12, wherein the roller operation key outputs the operational signal by performing a rolling operation.

14. The optical pen of claim 12, wherein the roller operation key outputs the operational signal by performing a buttoning operation.

15. The optical pen of claim 14, wherein the buttoning operation fulfills a right key operation of a traditional mouse.

16. The optical pen of claim 12, wherein the click operational signal is produced from the operation circuit by performing a clicking operation with the optical pen nib.

17. The optical pen of claim 16, wherein the clicking operation fulfills a left key operation of a traditional mouse.

18. The optical pen of claim 12, wherein the signal of reflected light is an index signal on a display of the electronic device.
